(19) United States
(12) Patent Application Publication
(10) Pub. No.: US 2024/0020589 A1
(43) Pub. Date: Jan. 18, 2024

(54) SELECTING FORECASTING ALGORITHMS USING MOTIFS AND CLASSES

(71) Applicant: Verint Americas Inc., Alpharetta, GA (US)

(72) Inventors: Jonathan Silverman, Palo Alto, CA (US); Nicholas Mortimer, Sheffield (GB); Cynthia Freeman, Spokane Valley, WA (US)

(21) Appl. No.: 17/812,282

(22) Filed: Jul. 13, 2022

(51) Int. Cl. G06Q 10/04; G06N 5/00; G06N 20/00

(52) U.S. Cl. CPC G06Q 10/04; G06N 5/003; G06N 20/00

(57) ABSTRACT

Methods and systems for selecting a forecasting algorithm to use for a forecast for a time interval are provided. A class is a series of time intervals that is selected by an entity from time series data that relates to external data or is a series of time intervals from the time series data that corresponds to a motif. The time series data is processed by a computer to identify motifs, and classes are generated based on each identified motif. A user may further identify one or more classes in the time series data. For each class, the forecasting algorithm that best predicts the historical demand data for time intervals associated with the class is determined. Later, when the entity desires to receive a forecast for a future time interval, the class associated with the future time interval is determined. The forecasting algorithm determined to best predict demand for the determined class is then used.

### BACKGROUND

Businesses, or other entities, use forecasting algorithms to make predictions srelated to demand for products and services at future times. These predictions are used to optimize production or for employee scheduling. For example, an entity such as a call center may use a prediction algorithm to predict the number of communications that will be received at a future date. The predicted number of communications can be used to select the optimal number of agents to work at the future time.

Currently, there are many forecasting algorithms available for entities to choose from. Even though an entity may train each algorithm to make predictions using its own historical demand data, because of differences in how each algorithm works, each algorithm may have different demand predictions for the same future time period. Choosing which forecasting algorithm to use for a specific time interval can be a difficult task.

### SUMMARY

The present disclosure describes methods and systems for selecting a forecasting algorithm to use for a forecast for a time interval. A class is a series of time intervals that is selected by an entity from time series data that relates to external data or is a series of time intervals from the time series data that corresponds to a motif. Time series data in this context includes historical demand data (e.g., average communication volume) for the entity at various time intervals in the past. The time series data is processed by a computer to identify motifs, and classes are generated based on each identified motif. The entity may further identify one or more classes in the time series data. For each class, the forecasting algorithm that best predicts the historical demand data for time intervals associated with the class is determined. Later, when the entity desires to receive a forecast for a future time interval, the class associated with the future time interval is determined. The forecasting algorithm determined to best predict demand for the determined class is then used to predict the demand for the future time interval.

In an embodiment, a method for selecting a forecasting algorithm for a class is provided. The method includes receiving time series data by a computing device. The time series data includes a plurality of time intervals and each time interval is associated with an interval value. The method includes receiving a plurality of forecasting algorithms by the computing device. The method includes receiving a set of classes by the computing device. Each class in the set of classes is associated with a plurality of subsequences of the time series data, and each of the plurality of subsequences comprises a time interval of the plurality of time intervals. The method further includes, for each class of the set of classes, selecting a forecasting algorithm from the plurality of forecasting algorithms based on the subsequences of the time series data associated with the class by the computing device. The method includes receiving a request to forecast the interval value for a future time interval by the computing device. The method includes determining a class of the set of classes that is associated with the future time interval by the computing device. The method includes using the forecasting algorithm selected for the determined class to predict the interval value for the future time interval by the computing device. The method includes providing the predicted interval value for the future time interval by the computing device.

Embodiments may include some or all of the following features. The predicted interval value is one of a communication volume, an average handling time, or a shrinkage. The method may further include one or more of scheduling one or more workers to work during the future time interval based on the predicted interval value and generating a hiring plan for the future time interval. Selecting the forecasting algorithm from the plurality of forecasting algorithms based on the subsequences of the time series data associated with the class may include selecting the forecasting algorithm with a minimum associated forecast error when predicting the interval value for time intervals from the plurality of subsequences of the time series data associated with the class. Each class of the set of classes may be one of a user class or a subsequence class. Some or all of the subsequence classes may correspond to motifs. The method may further include receiving a set of external data values by the computing device, and for at least one class in the set of classes, selecting the plurality of subsequences of the time series data for the at least one class based on the set of external data values.

In an embodiment, a method is provided. The method includes receiving time series data by a computing device. The time series data includes a plurality of time intervals and each time interval is associated with an interval value. The method includes receiving a plurality of forecasting algorithms by the computing device. The method includes receiving a set of classes by the computing device. Each class in the set of classes is associated with a plurality of subsequences of the time series data, and each of the plurality of subsequences includes a time interval of the plurality of time intervals. The method includes training each forecasting algorithm to predict the interval value using a portion of the time series data by the computing device. The method includes, for each time interval of the plurality of time intervals of the time series data that is not in the portion: for each forecasting algorithm of the plurality of forecasting algorithms: predicting the interval value for the time interval using the forecasting algorithm by the computing device; and determining a difference between the interval value associated with the time interval in the time series data and the predicted interval value for the time interval by the computing device. The method further includes training a selection model by the computing device using the received time series data, the set of classes, and the determined differences for each forecasting algorithm for each time interval of the plurality of time intervals of the time series data.

Embodiments may include some or all of the following features. The method may further include receiving a request to forecast the interval value at a future time interval, using the selection model to select a forecasting algorithm of the plurality of forecasting algorithms for the future time interval, using the selected forecasting algorithm to predict the interval value for the future time interval, and providing the predicted interval value for the future time interval. The method may further include one or more of scheduling one or more workers to work during the future time interval based on the predicted interval value and generating a hiring plan for the future time interval. The interval value may be one of a communication volume, an average handling time, or a shrinkage. The method may further include receiving external data by the computing device. The external data may include a set of external values and each external value of the set of external values is associated with a time interval of the plurality of time intervals. The method may further include training the selection model using the received time series data, the set of classes, the determined differences for each forecasting algorithm for each time interval of the plurality of time intervals of the time series data, and the external data. The selection model may include a decision tree. For one or more classes of the set of classes, some or all of the subsequences of the plurality of subsequences of the time series data associated with the class may be selected by an entity computing device. The classes in the set of classes may include one or more of user classes or subsequence classes. Some or all of the subsequence classes may correspond to motifs.

In an embodiment, a system is provided. The system includes one or more processors, and a computer-readable medium storing computer-executable instructions that when executed by the one or more processors cause the system to receive time series data. The time series data includes a plurality of time intervals and each time interval is associated with an interval value. The computer-readable medium storing computer-executable instructions that when executed by the one or more processors cause the system to receive a plurality of forecasting algorithms and receive a set of external data values. Each external value in the set of external values is associated with a time interval of the plurality of time intervals. The computer-readable medium storing computer-executable instructions that when executed by the one or more processors cause the system to select at least one class based on the set of external data values. The at least one class is associated with a plurality of subsequences of the time series data, and each of the plurality of subsequences comprises a time interval of the plurality of time intervals. The computer-readable medium storing computer-executable instructions that when executed by the one or more processors cause the system to train each forecasting algorithm of the plurality of forecasting algorithms to predict the interval value using a portion of the time series data, for each time interval of the plurality of time intervals of the time series data that is not in the portion, for each forecasting algorithm of the plurality of forecasting algorithms: predict the interval value for the time interval using the forecasting algorithm, and determine a difference between the interval value associated with the time interval in the time series data and the predicted interval value for the time interval. The computer-readable medium storing computer-executable instructions that when executed by the one or more processors cause the system to train a selection model using the received time series data, the at least one class, and the determined differences for each forecasting algorithm for each time interval of the plurality of times intervals of the time series data.

Embodiments may include some or all of the following features. The computer-readable medium storing computer-executable instructions that when executed by the one or more processors cause the system to receive a request to forecast the interval value at a future time interval, use the selection model to select a forecasting algorithm of the plurality of forecasting algorithms for the future time interval, use the selected forecasting algorithm to predict the interval value for the future time interval; and provide the predicted interval value for the future time interval. Each class in the set of classes may include one or more of a user class or a subsequence class.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The foregoing summary, as well as the following detailed description of illustrative embodiments, is better understood when read in conjunction with the appended drawings. For the purpose of illustrating the disclosed embodiments, there is shown in the drawings example constructions of the embodiments; however, the possible embodiments are not limited to the specific methods and instrumentalities disclosed. In the drawings:

FIG. 1 illustrates an example environment for selecting forecasting algorithms based on classes according to certain embodiments;

FIG. 2 illustrates an example flow diagram of a method for creating one or more classes according to certain embodiments;

FIG. 3 illustrates an example flow diagram of a method for selecting a forecasting algorithm and for generating a forecast for a future time using classes according to certain embodiments;

FIG. 4 illustrates an example flow diagram of a method for training a selection model to select forecasting algorithms based on classes and external data according to certain embodiments;

FIG. 5 illustrates an example flow diagram of a method for determining an a forecasting algorithm using a selection model according to certain embodiments; and

FIG. 6 is a schematic diagram of computer hardware that may be utilized to implement forecasting algorithm selection in accordance with the disclosure according to certain embodiments.

### DETAILED DESCRIPTION

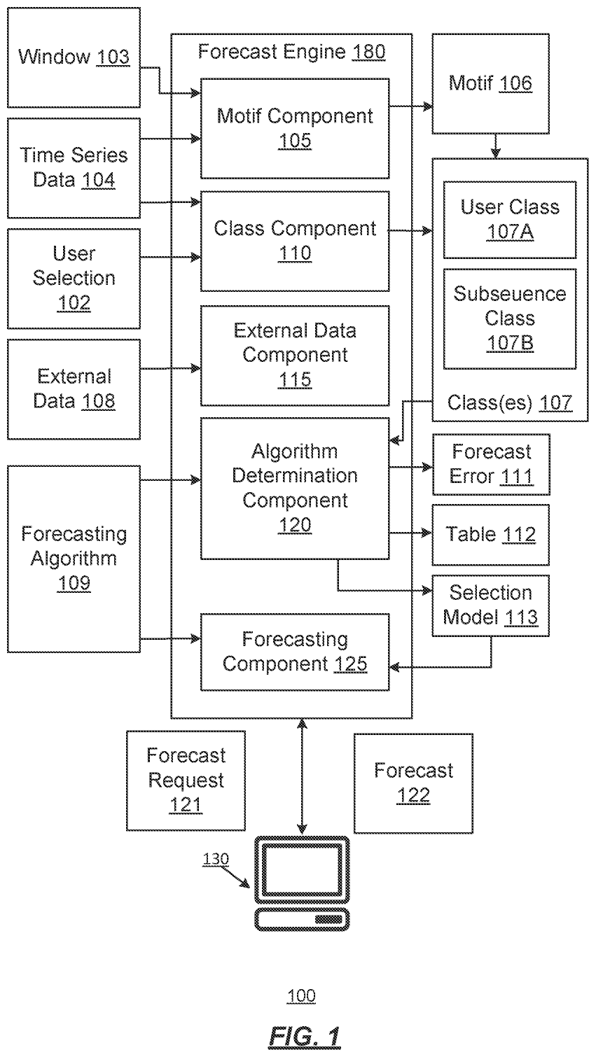

FIG. 1 is an illustration of an example environment 100 for selecting forecasting algorithms 109 based on classes 107 and external data 108. Entities use forecasting algorithms 109 to predict interval values at future time intervals based on interval values observed or measured at past times. A predicted interval value at a future time is known as a forecast 122. For an entity such as a call center that receives and handles communications, the forecast 122 may be a communication volume (e.g., number of calls or messages received) for a future time, an average handling time for a future time, or for a shrinkage (e.g., total number of agents serving customers divided by total number of unavailable agents) for a predicted time. The predicted communication volume may be for all communication types or may be for a specific communication type such as e-mail, telephone, or SMS. The predicted communication volume or average handling time may further relate to a particular communication topic or subject such as technical support or billing, for example.

Entities have many forecasting algorithms 109 to choose from. Examples include Autoregressive models (such as ARIMA and SARIMA), Exponential Smoothing, XGBoost, Prophet, Deep Learning, DeepAR, N-Beats, and Temporal Fusion Transformer. Because of differences in how each forecasting algorithm 109 works, each forecasting algorithm 109 may predict a different forecast 122 for a future time interval, even when trained using the same training data. Because entities rely on forecasts 122 when making future decisions such as planning, scheduling, and hiring, choosing the most accurate forecasting algorithm 109 is important.

A motif 106 is a repeating pattern of similar interval values found in time series data 104. In the case of the environment 100, the time series data 104 may include observed values (e.g., communication volumes) for the entity at a series of past consecutive time intervals. In some embodiments, the time series data 104 may include interval values measured at time intervals including every hour, every thirty minutes, every fifteen minutes, or every minute. Other time intervals may be used.

In a call center, examples motifs 106 for an entity may include an observed increase in communication volume for the entity that occurs every Friday between 4 and 6 pm, an observed decrease in communication volume that occurs every Monday between 9 am and 11 am, or an observed increase in communication volume that occurs yearly during the week before Christmas along with an observed decrease in communication volume that occurs between Christmas and New Year's Day. Motifs 106 may repeat daily, weekly, monthly, or even yearly. As will be described further below, motifs 106 are identified in time series data 104 by computing devices using software such as STUMPY.

To help an entity select a forecasting algorithm 109 to use for a forecast 122, the environment 100 may include a forecast engine 180. The forecast engine 180 may select a forecasting algorithm 109 to use for a forecast 122 based on what are known as classes 107. As used herein classes 107 may include, but are not limited to, a user class (or classes) 107A and a subsequence class (or classes) 107B.

The user class 107A is a set of time intervals or subsequences of the time series data 104 that are identified by a user or administrator based on external data or events. The user class 107A may be time intervals from the time series data that a user or administrator of an entity believes to be linked or related, but that may not repeat or whose values are not sufficiently similar to be identified as a motif 106. Returning to the call center example, an administrator may determine that the time intervals around the American summer holidays of Memorial Day, the Fourth of July, and Labor Day likely have similar or related interval values such as communication volume, however those interval values may not be similar enough to constitute a motif 106. Accordingly, the administrator may select the time intervals from the time series data 104 associated with these summer holidays for a user class 107A called “Summer Holidays”. As will be described further below, time intervals for user classes 107A may be selected based on their association with external data 108.

A subsequence class 107B may be the top k motifs 106 within the time series data 104, as described below. In addition, in some embodiments, a subsequence class 107B may include a set of time intervals or subsequences of the time series data 104 that are not part of any motif 106 or user class 107A.

The forecast engine 180 may determine one or more motifs 106 for the entity based on the time series data 104 associated with the entity. The time series data 104 for an entity may be provided by an entity computing device 130. The forecast engine 180 may create a subsequence class 107B corresponding to the top k motifs 106. The entity may further identify or select one or more user classes 107A from the time series data 104. The forecast engine 180 may then determine the forecasting algorithm that 109 performs the best for each class 107 (user class 107A and/or subsequence class 107B) when predicting interval values of the time series data 104. Later, when the entity sends a forecast request 121 to the forecast engine 180, the forecast engine 180 may determine if the forecast request 121 is for a future time interval that is associated with a class 107 for the entity. If so, the forecast engine 180 may use the forecasting algorithm 109 that was determined to perform the best for that class 107. The forecast engine 180 is described in further detail below. Depending on the embodiment, the time intervals may have a variety of durations including five minutes, ten minutes, one hour, etc.

Using classes 107 to select forecasting algorithms 109 is an improvement to any technological field that relies on forecasting. Previously, entities would select a single forecasting algorithm 109 that showed the best performance when predicting values across all or most of their historical data (i.e., time series data 104). However, some forecasting algorithms 109, while not having the best overall performance across all of the historical data, may have the best performance for historical data associated with certain classes 107. According, by considering classes 107 when selecting a forecasting algorithm 109 for a forecast, the accuracy of the forecasts will be improved which is an improvement to any technological field that relies on forecasting.

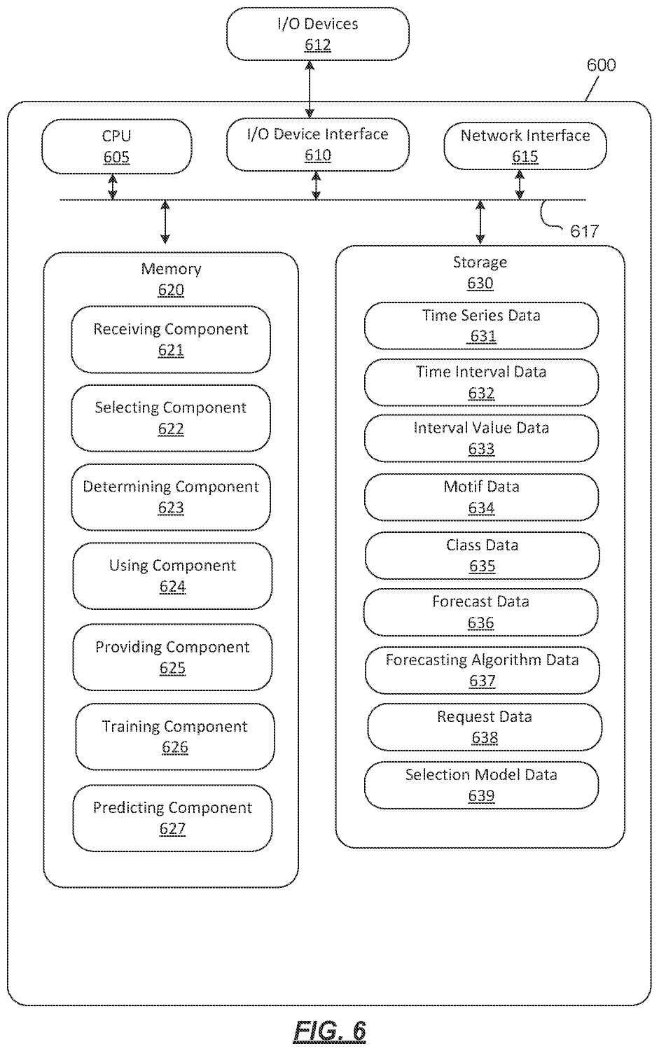

In the example shown, the forecast engine 180 may include several components, including but not limited to, a motif component 105, a class component 110, an external data component 115, an algorithm determination component 120, and a forecasting component 125. Each of the components 105, 110, 115, 120, and 125 may be implemented together or separately using one or more computers such as the computer 600 illustrated with respect to FIG. 6.

The motif component 105 may determine one or more motifs 106 for entity based on time series data 104 provided by the entity computing device 130. The time series data 104 for an entity may include observed interval values for a plurality of past time intervals. The observed interval values may include communication volume (i.e., how many communications were received during a past time interval), average handling time (i.e., what was the average amount of time that it took to handle a communication during the past time interval), and shrinkage (i.e., what was the percentage of non-productive time per employee or agent that worked at the time interval).

The motif component 105 may determine the motifs 106 for an entity from the time series data 104. In some embodiments, the motif component 105 may determine the motifs 106 for the time series data 104 using the STUMPY software tool. The STUMPY tool takes as an input the time series data 104 and computes a matrix profile for the time series data 104. This matrix profile is then used to determine the motifs 106 for the entity. Other methods for identifying motifs 106 may be used.

In some embodiments, the motif component 105 may take as an input the time series data 104 and a window 103. The window 103 may be a size of a time interval measured from some time t during which the motif component 105 may seek to discover a motif 106. Example window 103 sizes include one hour, one day, several days, or one week. Other motif 106 sizes may be considered.

The motif component 105 may output the motifs 106 determined for an entity. Each motif 106 may identify subsequences of time intervals from the time series data 104 that are associated with the motif 106. In some embodiments, the motif component 105 may output all of the motifs 106 determined for an entity or may output only the top k motifs 106 determined for an entity. For example, depending on the embodiment, the motifs 106 may be ranked based on how closely the pattern corresponding to the motif 106 fits each instance of the motif in the time series data 104. As noted above, the top k motifs 106 may be identified as one or more subsequence classes 107B.

The external data component 115 may receive external data 108 from one or more external or internal data sources. The external data 108 may include one or more external data values for some or all of the time intervals associated with the time series data 104. However, rather than having demand-related values for an entity such as communication volume, the external data 108 may include external data values from external data sources that may be relevant to the interval values from the time series data 104. Examples of external data 108 may include data that is external to the entity such as weather data for each time interval (e.g., temperature, humidity, and precipitation), event data for each time interval (e.g., was there a professional sporting event or other popular television event occurring during the time interval), and financial data (e.g., what was the percent increase or decrease for the Dow Jones Industrial Average at the time interval). Other external data 108 may be considered.

The external data 108 may further include data that is associated with the entity. Where the entity is a call center the external data 108 may include data such as data related to the types of communications being received at each time. This internal data may include product releases of the entity, sales or marketing promotions ran by the entity, and financial events related to the entity.

The class component 110 may create one or more classes 107 from the time series data 104. As described above, the user class 107A may be a subsequence, or multiple subsequences, of time intervals from the time series data 104 that are selected for an entity by a user or administrator. The class component 110 may create one or more subsequence classes 107B, which may include the top k motifs 106 within the time series data 104.

In some embodiments, a user or administrator may select the time intervals for each user class 107A based on external data values of the external data 108 associated with each time interval. For example, a user or administrator may desire to create a user class 107A that includes time intervals where the external temperature exceeded 90 degrees. Accordingly, the class component 110 may use external data 108 that includes the temperature during each time to identify time intervals from the time series data 104 where the temperature was above degrees and may use the identified time intervals to create a user class 107A. In some embodiments, the user class 107A may be automatically selected based on certain criteria, such as, holidays, special events, product releases, etc.

In some embodiments, the class component 110 may provide a user interface through which the user or administrator may view the time intervals of the time series data 104 along with selected external data 108. The class component 110 may receive a user selection 102 of time intervals from the time series data 104 and may use the selected time intervals to create the user class 107A for the entity. The class component 110 may associate an identifier or name with the created user class 107A. In some embodiments, the user or administrator may select the time series data 104 for a user class 107A, alternatively the class component 110 may select the time series data 104 based on the external data 108 selected by the user or administrator. For subsequence classes 107B, the class component 110 may create a subsequence class 107B for some or all time intervals of the time series data 104 that were not placed in any user class 107A.

The algorithm determination component 120 may determine a forecasting algorithm 109 from a set of forecasting algorithms 109 for each class 107 (user class 107A and/or subsequence class 107B, alone or in combination) associated with the entity. In some embodiments, the determined forecasting algorithm 109 for a class 107 is the forecasting algorithm 109 that minimizes a forecast errors 111 for time intervals associated with the class 107. The forecast error 111 for a forecasting algorithm 109 for a time interval may be calculated as a difference between the measured or actual interval value for the time interval from the time series data 104 and the interval value predicted for the time interval by the forecasting algorithm 109. How the algorithm determination component 120 computes the forecast error 111 for a class 107 is described below.

In one embodiment, the algorithm determination component 120 may calculate the forecast error 111 for each forecasting algorithm 109 for each class 107 associated with an entity by first training the forecasting algorithm 109 using a portion of the time series data 104. For example, the portion may be from ten percent to up to sixty percent of the time series data 104.

After training the forecasting algorithm 109, the algorithm determination component 120 may extract the subsequences of time intervals associated with each class 107 from the portion of the time series data 104 not used to train the forecasting algorithm 109. For each time interval in the extracted subsequences, the algorithm determination component 120 may predict the interval value for the time interval using each of the forecasting algorithm 109. The algorithm determination component 120 may then, for each time interval, determine differences between the predicted interval values by each forecasting algorithm 109 and the actual observed interval value for the time interval from the times series data 104.

In some embodiments, for each class 107, the algorithm determination component 120 may calculate a forecast error 111 for each of the forecasting algorithm 109 with respect to the class 107. The forecast error 111 for a forecasting algorithm 109 with respect to a class 107 may be an average difference calculated for each time interval from the subsequences class 107 using the forecasting algorithm 109. In some embodiments, the forecast error 111 may be a mean absolute percentage error. Other error calculations may be used.

In some embodiments, the algorithm determination component 120 may determine the forecasting algorithm 109 with the smallest or least forecast error 111 for a class 107 as the forecasting algorithm 109 for the class 107. In other embodiments, the algorithm determination component 120 may determine the forecasting algorithm 109 from among the forecasting algorithms 109 with the least forecast errors 111 for a class 107 as the forecasting algorithm 109 for the class 107. For example, the algorithm determination component 120 may determine the top five or ten forecasting algorithms 109 based on the forecast errors 111 for a class 107 and may determine the forecast algorithm 109 from among the top five or top ten forecasting algorithms 109.

In some embodiments, rather than just determine a forecasting algorithm 109 for each class 107, the algorithm determination component 120 may use the motifs 106, classes 107, external data 108, and time series data 104 to train a selection model 113 for an entity. The selection model 113 may receive as an input a future time interval associated with a forecast request 121 and a predicted value of external data 108 for the future time interval. The selection model 113 may then identify a forecasting algorithm 109 to use for the request 121.

To create the selection model 113, the algorithm determination component 120 may first train the forecasting algorithms 109 using a portion of the time series data 104 as described above. After training the forecasting algorithms 109, the algorithm determination component 120 may begin constructing a table 112 that will be used to train the selection model 113. In some embodiments, the algorithm determination component 120 may generate the table 112, by for each time interval of the time series data 104 not used to train the forecasting algorithms 109 and that is part of a class 107, using each forecasting algorithm 109 to predict an interval value for the time interval.

The algorithm determination component 120 may add each predicted interval value may be added to a row of the table 112 along with the time interval. For each time interval of the time series data 104, the algorithm determination component 120 may determine a difference between each of the predicted interval values and the actual measured interval value at the time interval and may add the differences to the row of the table 112 associated with the time interval. Also included in the row of the table 112 for a time interval may be an indication of the class 107 associated with the time interval, and an indication of which forecasting algorithm 109 performed the best for the time interval. In addition, each row may include an external data value from the external data 108 that is associated with the time interval corresponding to the row.

Where there are multiple classes 107 being considered, each class 107 may be assigned a number by the algorithm determination component 120. With respect to the subsequence classes 107B, each subsequence class 107B may be assigned a number that corresponds to the motif 106 that corresponds to the subsequence class 107B. For the subsequence class 107B that includes subsequences not assigned to any other class 107, the subsequence may be assigned a number such as zero. With respect to the user classes 107A, each user class 107A may also be assigned a number.

For example, the following table 1 is an illustration of an example table 112 that is generated by the algorithm determination component 120. In the example shown, there are two forecasting algorithms 109 (e.g., A and B), one motif 106, and one class 107. The external data 108 may include the temperature at each time interval of the time series data 104 and may indicate whether or not the time interval is during a day that is before or after a holiday. Each row of the table corresponds to a different time interval from the time series data 104.

The column “Interval Value” holds the actual interval value measured or observed for the time interval in the time series data 104. For example, the interval value for an interval may include the communication volume, average handling time, or shrinkage measured during the interval. The column “Holiday” includes a 1 if the time interval is during a day that is before or after a holiday, and a 0 otherwise as indicated by the external data 108. The column “Temp” holds the temperature at the time from the external data 108. The column “Sc” identifies which subsequence class 107B is associated with the time interval. The column “UC” identifies which user class 107A is associated with the time interval. The column “A” identifies the value predicted by the forecasting algorithm A. The column “D_{A}” identifies the difference between the actual interval value for the time and the predicted interval value by the forecasting algorithm A for the time interval. The column “B” identifies the interval value predicted by the forecasting algorithm B. The column “D_{B}” identifies the difference between the actual interval value for the time interval and the predicted interval value by the forecasting algorithm B for the time interval. The column “Best” identifies which forecasting algorithm 109 performed the best for the time interval.

TABLE 1

| Interval | | | | | | | | | |
|---|---|---|---|---|---|---|---|---|---|
| Value | Holiday | Temp | SC | UC | A | D_{A} | B | DB | Best |
| 67 | 1 | 77 | 0 | 1 | 67 | 0 | 60 | 7 | A |
| 46 | 1 | 78 | 0 | 1 | 44 | 2 | 46 | 0 | B |
| 35 | 0 | 81 | 0 | 1 | 37 | 2 | 30 | 5 | A |
| 55 | 0 | 67 | 0 | 1 | 58 | 3 | 50 | 5 | A |
| 70 | 0 | 88 | 2 | 0 | 67 | 3 | 70 | 0 | B |
| 72 | 0 | 89 | 2 | 0 | 70 | 2 | 71 | 1 | B |
| 59 | 0 | 60 | 0 | 0 | 63 | 4 | 58 | 1 | B |
| 58 | 0 | 64 | 0 | 0 | 60 | 2 | 58 | 0 | B |
| 56 | 0 | 66 | 0 | 0 | 58 | 2 | 55 | 1 | B |

After generating the table 112, the algorithm determination component 120 may use the table 112 to train the selection model 113. In some embodiments, the selection model 113 may be a decision tree that is constructed using the data from the table 112. Any method for training or constructing a decision tree may be used.

The forecasting component 125 may receive a forecast request 121 from the entity computing device 130 associated with an entity. The forecast request 121 may indicate a future time interval.

In some embodiments, in response to the forecast request 121, the forecasting component 125 may determine the class 107 associated with the future time interval. The forecasting component 125 may select the forecasting algorithm 109 with the determined best performance for forecasting interval values for time intervals associated with the class 107.

The forecasting component 125 may use the selected forecasting algorithm 109 to predict an interval value for the future time interval associated with the forecast request 121. The interval value may be related to an expected demand at the future time interval such as communication volume. The determined interval value may be provided to the entity computing device 130 as the forecast 122. The entity may then use the forecast 122 for variety of demand-based planning purposes. For example, if the entity is a call center, the entity may use the forecast 122 for the future time interval to determine a number of agents or workers to schedule during the future time interval to meet a desired level of service.

In some embodiments, in response to receiving a forecast request 121, the forecasting component 125 may use the selection model 113 to select the forecasting algorithm 109 to use to generate the forecast 122. The forecasting component 125 may provide as an input to the selection model 113, the future time interval, the class 107 associated with the future time, and a predicted or known external data value from the external data 108 for the future time interval. For example, for external data 108 such as temperature, the external data component 115 may use a weather service to predict the temperature at the future time interval.

The selected forecasting algorithm 109 may be used to predict the interval value for the future time interval as described above. The predicted interval value may be provided to the entity computing device 130 as the forecast 122. The entity may then use the forecast 122 for variety of demand-based planning purposes. For example, if the entity is a call center, the entity may use the forecast 122 for the future time to determine a number of agents to schedule during the future time interval to meet a desired level of service or to determine a hiring plan for a future week. Other entities that may use the forecast 122 may include back-office operations (in verticals such as banking and insurance) and retail bank branches. Other types of entities may be supported.

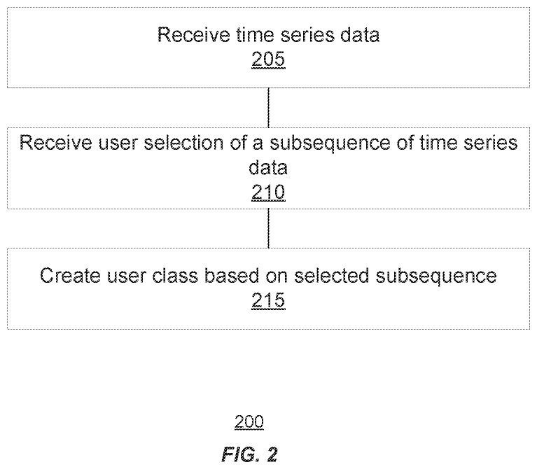

FIG. 2 illustrates an example flow diagram of a method 200 for creating one or more classes according to certain embodiments. The method 200 may be implemented by the class component 110 of the forecast engine 180.

At block 205, time series data is received by the class component 110. The class component 110 may receive the time series data 104 from an entity computing device 130. The time series data 104 may be a plurality of time intervals and each time interval may be associated with an interval value.

At block 210, a user selection of a subsequence of the time series data is received from the entity computing device 130. The class component 110 may receive the user selection 102 through a user interface provided by the class component 110. The user selection 102 may indicate one or more subsequences of the time intervals from the time series data 104 that the user would like to add to a class 107. The user may be associated with the entity that provided the time series data 104. The class 107 may be a user class 107A.

In some embodiments, the user may select the subsequence of the time series data 104 based on external data 108. The external data 108 may include external data values related to various events for each time of the time series data 104. For example, the external data 108 for a time may include if the time was associated with a holiday, the recorded temperature of the time, or whether the time occurred during a popular tv or sporting event.

At block 215, a user class is created based on the selected subsequence by the class component 110. The class component 110 may create the user class 107A from the selected one or more subsequences.

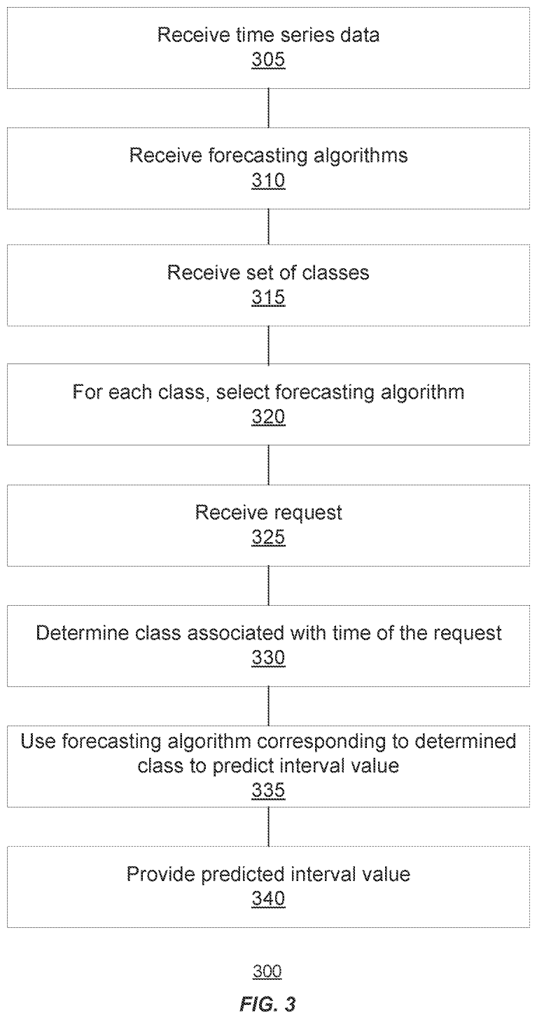

FIG. 3 illustrates an example flow diagram of a method 300 for selecting a forecasting algorithm and for generating a forecast for a future time interval using classes according to certain embodiments. The method 300 may be implemented by the forecast engine 180.

At block 305, time series data is received by the algorithm determination component 120. The algorithm determination component 120 of the forecast engine 180 may receive the time series data 104 from an entity. The time series data 104 may include a plurality of interval values and each interval value may be associated with a time. The interval values may be the communication volumes observed for the entity at each time. Other interval values may be supported.

At block 310, forecasting algorithms are received by the algorithm determination component 120. The algorithm determination component 120 may receive the forecasting algorithms 109. In some embodiments, the algorithm determination component 120 may receive the forecasting algorithms 109 from the entity computing device 130 that provided the time series data 104. For example, the entity associated with the entity computing device 130 may have selected the forecasting algorithms 109 for consideration for generating forecasts 122 for the entity.

At block 315, a set of classes is received by the algorithm determination component 120. The algorithm determination component 120 may receive the classes 107 from the class component 110. The classes 107 may include user classes 107A and subsequence classes 107B. With respect to user classes 107A, a user or administrator may have created each user class 107A in the set of classes 107 based on external data 108. With respect to subsequence classes 107B, each subsequence class 107B may be based on a corresponding motif 106 discovered in the time series data 104 by the motif component 105, for example, the top k motifs 106. Each class 107 may include one or more subsequences of the time intervals from the time series data 104.

At block 320, for each class, a forecasting algorithm is selected by the algorithm determination component 120. The algorithm determination component 120 may select the forecasting algorithm 109 for a class 107 by, for each forecasting algorithm 109, predicting interval values for the time intervals in the time series data 104 that are associated with the class 107. The algorithm determination component 120 may then determine differences between the predicted interval values and the actual observed interval values for each time interval. The algorithm determination component 120 may determine the forecast error 111 for the forecasting algorithm 109 using the determined differences. In some embodiments, the algorithm determination component 120 may then select the forecasting algorithm 109 with the least forecast error 111 for the class 107. In other embodiments, the select the forecasting algorithm 109 from among a subgroup of forecasting algorithms 109 with the lowest forecast error 111 for the class 107.

At block 325, a request is received by the forecasting component 125. The request may be a forecast request 121. The forecast request 121 may be received by the forecasting component 125 from a computing device 130 of the entity associated with the time series data 104. The forecast request 121 may indicate a future time interval for which the entity is requesting a forecast 122.

At block 330, a class associated with the time interval of the request is determined by the forecasting component 125. The forecasting component 125 may determine the class 107 associated with the request by determining if the future time interval associated with the forecast request 121 falls within any time intervals associated with a class 107 of the set of classes 107. In some embodiments, every time interval may be associated with a class 107 of the set of classes, in other embodiments some time intervals may not be associated with a class 107.

At block 335, the forecasting algorithm corresponding to the determined class is used to predict the interval value by the forecasting component 125. The forecasting component 125 may use the forecasting algorithm 109 that was determined to perform the best for the class 107 associated with the future time interval. The predicted interval value may be a predicted communication volume for the entity at the predicted time interval, a predicted average handling time, or a predicted shrinkage. If the future time interval was not associated with a class 107, a default forecasting algorithm 109 may be used to predict the interval value for the future time.

At block 340, the predicted interval value is provided by the forecasting component 125. The forecasting component 125 may provide the predicted interval value to the entity computing device 130 as the forecast 122. The entity may then use the forecast 122 for a variety of purposes including determining a number of employees or agents to schedule to work at the future time interval.

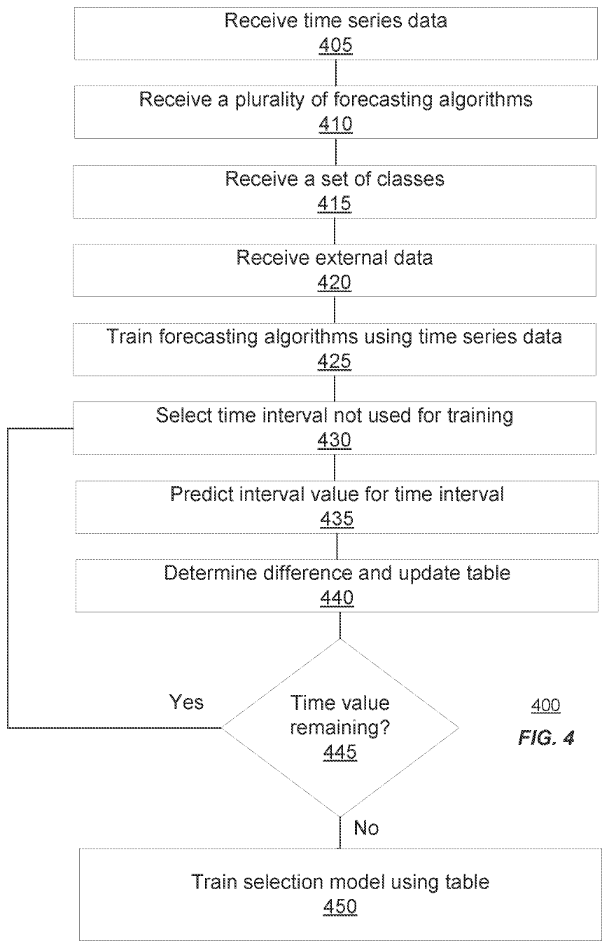

FIG. 4 illustrates an example flow diagram of a method 400 for training a selection model to select forecasting algorithms based on classes, and external data according to certain embodiments. The method 400 may be implemented by the algorithm determination component 120 of the forecast engine 180.

At block 405, time series data is received. The algorithm determination component 120 of the forecast engine 180 may receive the time series data 104 from an entity. The time series data 104 may include a plurality of interval values and each interval value may be associated with a time interval. The interval values may be the communication volumes average handling times, or shrinkages observed for the entity at each time interval. Other values may be supported.

At block 410, a plurality of forecasting algorithms is received by the algorithm determination component 120. The algorithm determination component 120 of the forecast engine 180 may receive the forecasting algorithms 109. In some embodiments, the algorithm determination component 120 may receive the forecasting algorithms 109 from the entity that provided the time series data 104. For example, the entity may have selected the forecasting algorithms 109 for consideration in generating forecasts 122 for the entity.

At block 415, a set of classes is received by the algorithm determination component 120. The algorithm determination component 120 may receive the classes from the class component 110. The classes 107 may include user classes 107A that were selected by the entity and subsequence classes 107B that correspond to the top k motifs 106. Each class 107 may include one or more subsequences of the time intervals from the time series data 104.

At block 420, external data is received by the algorithm determination component 120. The algorithm determination component 120 may receive the external data 108 from the external data component 115. The external data 108 may include data that independent of, or not part of, the entity associated with the time series data 104. The external data 108 may include external data values corresponding to some or all of the time intervals in the time series data 104. The external data 108 may include external data values related to the weather, current events, or financial information. The external data 108 being considered may be selected by a user or administrator associated with the entity.

At block 425, the forecasting algorithms are trained using the time series data 104 by the algorithm determination component 120. The algorithm determination component 120 may train each forecasting algorithm 109 of the set of forecasting algorithm 109 using a same portion of the time series data 104.

At block 430, a time interval not used for training is selected by the algorithm determination component 120. The algorithm determination component 120 may select a time interval from the time series data 104 that was not used to train the forecasting algorithms 109. The selected time interval may be a next time interval in a chronological order.

At block 435, an interval value for the time interval is predicted using each forecasting algorithm by the algorithm determination component 120. The algorithm determination component 120 may predict the interval value for the time interval using each of the forecasting algorithms 109.

At block 440, a difference between the predicted interval value and the actual interval value for the time interval is determined and the table is updated by the algorithm determination component 120 for each forecasting algorithm 109. The algorithm determination component 120 may determine a difference between each predicted interval value and the actual interval value associated with the time interval. The difference may be the forecast error 111.

The algorithm determination component 120 may update the table 112 by creating a row for the time interval. The row may include the determined difference for each forecast algorithm 109 and an indication of any class 107 that is associated with the time interval. The row may further include one or more external data values from the external data 108 for the time interval.

At block 445, whether there are any remaining time intervals in the time series data is determined by the algorithm determination component 120. If time intervals of the time series data 104 have not been considered, the method 400 may continue at block 430 where the next time may be considered. Else, the method 400 may continue at block 450.

At block 450, the selection model is trained using the table by the algorithm determination component 120. The algorithm determination component 120 may train the selection model 113 using the table 112. The selection model 113 may be a decision tree that selects a best forecasting algorithm 109 to use for a future time interval based on whether or not the future time interval is associated with a class 107, and any external data 108 predicted for the future time interval.

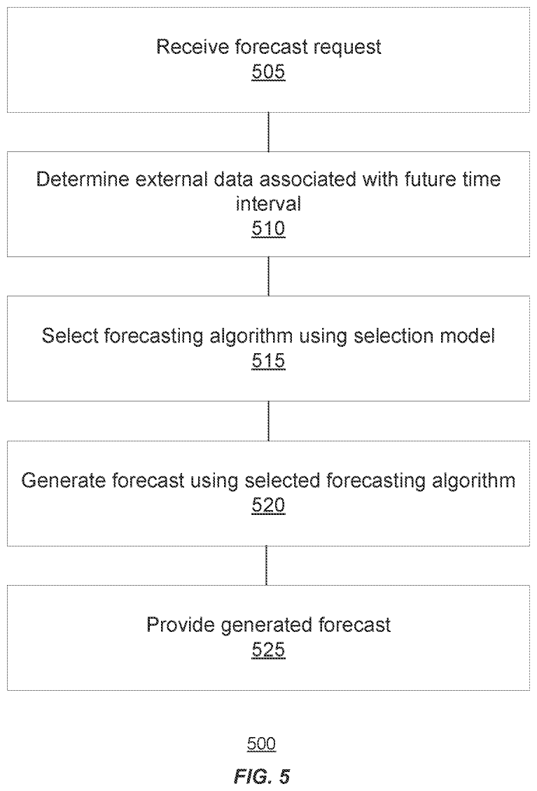

FIG. 5 illustrates an example flow diagram of a method 500 for determining a forecasting algorithm using a selection model according to certain embodiments. The method 500 may be implemented by the forecast engine 180.

At block 505, a forecast request is received by the forecasting component 125. The forecasting component 125 may receive the forecast request 121 from a computing device 130 of the entity associated with the time series data 104. The forecast request 121 may indicate a future time interval for which the entity is requesting a forecast 122.

At block 510, external data associated with the future time interval is determined by the forecasting component 125. The forecasting component 125 may receive an external data value of the external data 108 from an external data source. The external data value of the external data 108 may be a predicted external data value of the external data 108 at the future time interval associated with the request 121. For example, if the external data 108 is temperature, the forecasting component 125 may determine the predicted temperature for the future time interval from an external data source such as a weather forecasting service.

At block 515, a forecasting algorithm is selected using a selection model by the forecasting component 125. The forecasting component 125 may select the forecasting algorithm 109 using the selection model 113. The selection model 113 may take as an input the future time interval and the external data value of the external data 108 at the future time interval and may output the best suited forecasting algorithm 109. In addition, the selection model 113 may further take as an input an identifier of any class 107 known to contain the future time interval.

At block 520, a forecast is generated using the selected forecasting algorithm by the forecasting component 125. The forecasting component 125 may use the forecasting algorithm 109 that was selected by the selection model 113. The forecast 122 may predict a communication volume, an average handling time, or a shrinkage for the entity at the future time interval.

At block 525, the generated forecast is provided by the forecasting component 125. The forecasting component 125 may provide the forecast 122 to the entity. The entity may then use the forecast 122 for a variety of purposes including determining a number of employees or agents to schedule to work at the future time interval.

FIG. 6 illustrates examples of computers 600 that may include the kinds of software programs, data stores, and hardware that can implement motif determination and forecasting algorithm selection, as described above according to certain embodiments. As shown, the computing system 600 includes, without limitation, a central processing unit (CPU) 605, a network interface 615, a memory 620, and storage 630, each connected to a bus 617. The computing system 600 may also include an I/O device interface 610 connecting I/O devices 612 (e.g., keyboard, display and mouse devices) to the computing system 600. Further, the computing elements shown in computing system 600 may correspond to a physical computing system (e.g., a system in a data center) or may be a virtual computing instance executing within a computing cloud.

The CPU 605 retrieves and executes programming instructions stored in the memory 620 as well as stored in the storage 630. The bus 617 is used to transmit programming instructions and application data between the CPU 605, I/O device interface 610, storage 630, network interface 615, and memory 620. Note, CPU 605 is included to be representative of a single CPU, multiple CPUs, a single CPU having multiple processing cores, and the like, and the memory 620 is generally included to be representative of a random access memory. The storage 630 may be a disk drive or flash storage device. Although shown as a single unit, the storage 630 may be a combination of fixed and/or removable storage devices, such as fixed disc drives, removable memory cards, optical storage, network attached storage (NAS), or a storage area-network (SAN).

Illustratively, the memory 620 includes a receiving component 621, a selecting component 622, a determining component 623, a using component 624, a providing component 625, a training component 626, and a predicting component 627, all of which are discussed in greater detail above. Further, storage 630 includes time series data 631, time interval data 632, interval value data 633, motif data 634, class data 635, forecast data 636, forecasting algorithm data 637, request data 638, and selection model data 639, all of which are also discussed in greater detail above.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for selecting a forecasting algorithm for a class comprising:
receiving time series data by a computing device, wherein the time series data comprises a plurality of time intervals and each time interval is associated with an interval value;
receiving a plurality of forecasting algorithms by the computing device;
receiving a set of classes by the computing device, wherein each class in the set of classes is associated with a plurality of subsequences of the time series data, and wherein each of the plurality of subsequences comprises a time interval of the plurality of time intervals;
for each class of the set of classes, selecting a forecasting algorithm from the plurality of forecasting algorithms based on the subsequences of the time series data associated with the class by the computing device;
receiving a request to forecast the interval value for a future time interval by the computing device;
determining a class of the set of classes that is associated with the future time interval by the computing device;
using the forecasting algorithm selected for the determined class to predict the interval value for the future time interval by the computing device; and
providing the predicted interval value for the future time interval by the computing device.

2. The method of claim 1, wherein the predicted interval value is one of a communication volume, an average handling time, or a shrinkage.

3. The method of claim 1, further comprising one or more of scheduling one or more workers to work during the future time interval based on the predicted interval value and generating a hiring plan for the future time interval.

4. The method of claim 1, wherein selecting the forecasting algorithm from the plurality of forecasting algorithms based on the subsequences of the time series data associated with the class comprises selecting the forecasting algorithm with a minimum associated forecast error when predicting the interval value for time intervals from the plurality of subsequences of the time series data associated with the class.

5. The method of claim 1, wherein each class of the set of classes is one of a user class or a subsequence class.

6. The method of claim 5, wherein some or all of the subsequence classes correspond to motifs.

7. The method of claim 1, further comprising:
receiving a set of external data values by the computing device, wherein each external data value in the set of external data values is associated with a time interval of the plurality of time intervals; and
for at least one class in the set of classes, selecting the plurality of subsequences of the time series data for the at least one class based on the set of external data values.

8. A method comprising:
receiving time series data by a computing device, wherein the time series data comprises a plurality of time intervals and each time interval is associated with an interval value;
receiving a plurality of forecasting algorithms by the computing device;
receiving a set of classes by the computing device, wherein each class in the set of classes is associated with a plurality of subsequences of the time series data, and wherein each of the plurality of subsequences comprises a time interval of the plurality of time intervals;
training each forecasting algorithm to predict the interval value using a portion of the time series data by the computing device;
for each time interval of the plurality of time intervals of the time series data that is not in the portion:
for each forecasting algorithm of the plurality of forecasting algorithms:
predicting the interval value for the time interval using the forecasting algorithm by the computing device; and
determining a difference between the interval value associated with the time interval in the time series data and the predicted interval value for the time interval by the computing device; and
training a selection model by the computing device using the received time series data, the set of classes, and the determined differences for each forecasting algorithm for each time interval of the plurality of time intervals of the time series data.

9. The method of claim 8, further comprising:
receiving a request to forecast the interval value at a future time interval;
using the selection model to select a forecasting algorithm of the plurality of forecasting algorithms for the future time interval;
using the selected forecasting algorithm to predict the interval value for the future time interval; and
providing the predicted interval value for the future time interval.

10. The method of claim 9, further comprising one or more of scheduling one or more workers to work during the future time interval based on the predicted interval value and generating a hiring plan for the future time interval.

11. The method of claim 8, wherein the interval value is one of a communication volume, an average handling time, or a shrinkage.

12. The method of claim 8, further comprising receiving external data by the computing device, wherein the external data comprises a set of external values and each external value of the set of external values is associated with a time interval of the plurality of time intervals.

13. The method of claim 12, further comprising training the selection model using the received time series data, the set of classes, the determined differences for each forecasting algorithm for each time interval of the plurality of time intervals of the time series data, and the external data.

14. The method of claim 8, wherein the selection model comprises a decision tree.

15. The method of claim 8, wherein, for one or more classes of the set of classes, some or all of the subsequences of the plurality of subsequences of the time series data associated with the class are selected by an entity computing device.

16. The method of claim 8, wherein the classes in the set of classes comprise one or more of user classes or subsequence classes.

17. The method of claim 16, wherein some or all of the subsequence classes correspond to motifs.

18. A system comprising:
one or more processors; and
a computer-readable medium storing computer-executable instructions that when executed by the one or more processors cause the system to:
receive time series data, wherein the time series data comprises a plurality of time intervals and each time interval is associated with an interval value;
receive a plurality of forecasting algorithms;
receive a set of external data values, wherein each external value in the set of external values is associated with a time interval of the plurality of time intervals;
select at least one class based on the set of external data values, wherein the at least one class is associated with a plurality of subsequences of the time series data, and wherein each of the plurality of subsequences comprises a time interval of the plurality of time intervals;
train each forecasting algorithm of the plurality of forecasting algorithms to predict the interval value using a portion of the time series data;
for each time interval of the plurality of time intervals of the time series data that is not in the portion:
for each forecasting algorithm of the plurality of forecasting algorithms:
predict the interval value for the time interval using the forecasting algorithm; and
determine a difference between the interval value associated with the time interval in the time series data and the predicted interval value for the time interval; and
train a selection model using the received time series data, the at least one class, and the determined differences for each forecasting algorithm for each time interval of the plurality of times intervals of the time series data.

19. The system of claim 18, further comprising computer-executable instructions that when executed by the one or more processors cause the system to:
receive a request to forecast the interval value at a future time interval;
use the selection model to select a forecasting algorithm of the plurality of forecasting algorithms for the future time interval;
use the selected forecasting algorithm to predict the interval value for the future time interval; and
provide the predicted interval value for the future time interval.

20. The system of claim 18, wherein each class in the set of classes comprise one or more of a user class or a subsequence class.
